(19) United States
(12) Patent Application Publication
(10) Pub. No.: US 2011/0185871 A1
(43) Pub. Date: Aug. 4, 2011

(54) APPARATUS FOR CUTTING FOIL

(75) Inventors: Yun-Fei Lien, Tayuan (TW); Tao Huang, Huai An (CN); Bing-Yan Yu, Huai An (CN); Bing-Qing Dong, Huai An (CN); Shao-Jiang Zhang, Huai An (CN)

(73) Assignees: Hong Heng Sheng Electronical Technology (HuaiAn) Co., Ltd, Huai An City (CN); FOXCONN ADVANCED TECHNOLOGY INC., Tayuan (TW)

(21) Appl. No.: 12/915,008

(22) Filed: Oct. 29, 2010

(30) Foreign Application Priority Data
Jan. 30, 2010 (CN) 201020301974.0

(51) Int. Cl. B26D 5/20; B26D 7/00

(52) U.S. Cl. 83/416; 83/649; 83/436.5

(57) ABSTRACT

An apparatus for cutting foil strip from a spool includes a holding device, a pulling unit, a cutting unit, a brake unit, a detection unit, and a controller. The supporting is configured for receiving the spool. The pulling unit, the cutting unit, the brake unit are fixed on the holding device. The pulling unit is configured for pulling the foil apart from the spool to the cutting unit. The cutting unit is configured for cutting the foil into pieces. The brake unit is mechanically coupled to the reel and configured for applying a resistance to the spool. The detection unit is mechanically connected with to the reel and configured for sensing the rotation number of the spool. The controller is electronically connected to the sensor and the brake unit and configured for controlling the resistance the brake unit applying to the spool according signal of the detection unit.

### BACKGROUND

1. Technical Field

The present disclosure relates to material cutting, and particularly, to an apparatus for cutting foil from a reel.

2. Description of Related Art

Foil, such as copper foil, is widely used in printed circuit board manufacturing. The copper foil is generally wound around a spool. Before the copper foil is applied, it must be cut into shorter pieces of predetermined length. The cutting apparatus generally includes a pulling device configured for withdrawing the copper foil from the spool. As the volume of foil on the spool decreases gradually, weight of the foil and spool decreases gradually, and response to inertia thereon changes correspondingly, such that tension on the remaining foil is difficult to control.

What is needed, therefore, is an apparatus for cutting foil strip from a spool which can overcome the described limitations.

### BRIEF DESCRIPTION OF THE DRAWINGS

Many aspects of the present apparatus for cutting foil strip from a spool can be better understood with reference to the following drawings. The components in the drawings are not necessarily drawn to scale, the emphasis instead being placed upon clearly illustrating the principles of the present apparatus for cutting foil from a reel. Moreover, in the drawings, like reference numerals designate corresponding parts throughout the several views.

FIG. 1 is a schematic view of an apparatus for cutting foil strip from a foil reel in accordance with an embodiment of the present disclosure.

FIG. 2 is a cross-section taken along line II-II of FIG. 1, showing a detection unit of the apparatus of FIG. 1.

FIG. 3 is a block diagram of the apparatus of FIG. 1.

FIG. 4 is similar to FIG. 1, but showing the apparatus in an operational state.

### DETAILED DESCRIPTION OF THE EMBODIMENTS

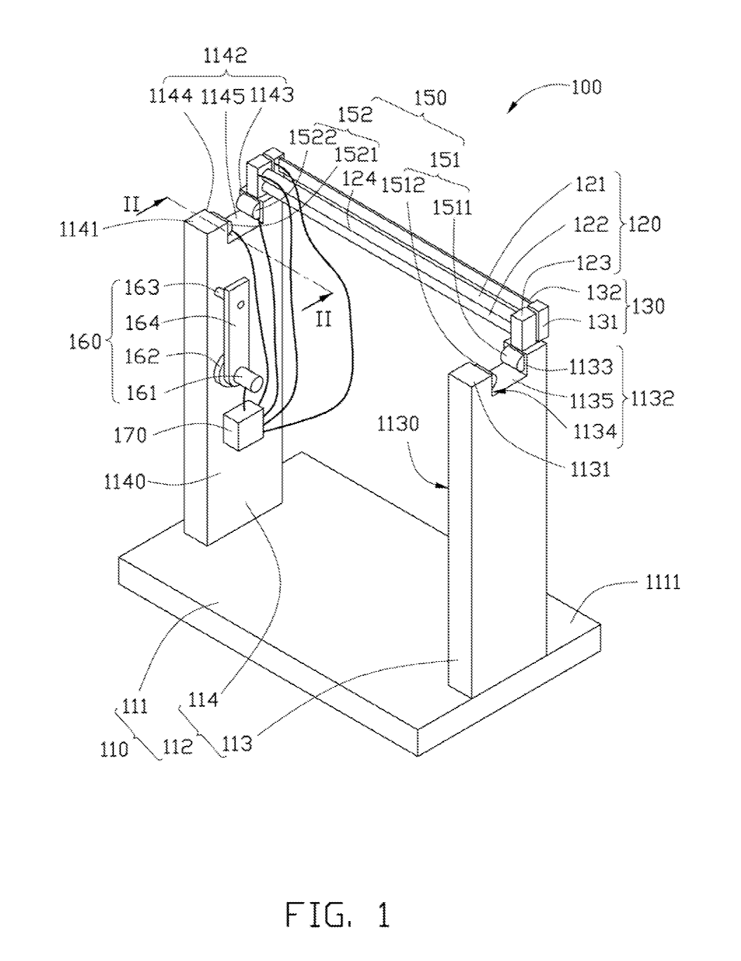

Referring to FIGS. 1, 2 and 4, an apparatus 100 configured for cutting foil strip from a reel according to an exemplary embodiment, is shown. The apparatus 100 includes a holding device 110, a pulling unit 120, a cutting unit 130, a brake unit 150, a detection unit 160, and a controller 170.

The holding device 110 is configured for supporting a foil reel 20, the pulling unit 120, the cutting unit 130, the brake unit 150, the detection unit 160, and the controller 170. In one embodiment, the holding device 110 includes a base 111, a first holder 113, and a second holder 114. The foil reel 20 includes a spool 21 and a foil 22 wound around the spool 21.

The base 111 has a rectangular first surface 1111 on which the first holder 113 and the second holder 114 are opposingly fixed and parallel, substantially perpendicular to the first surface 1111.

The first holder 113 has a first inner side surface 1130, and a first end surface 1131 adjoining the first inner side surface 1130. The first inner side surface 1130 is opposite to the second holder 114, and the first end surface 1131 is parallel to the first surface 1111. A first receiving space 1132 is defined in the first holder 113 and exposed at the first end surface 1131. The first receiving space 1132 has a substantially rectangular cross section. The first receiving space 1132 has a first side surface 1133, a second side surface 1134 opposite to the first side surface 1133, and a first bottom surface 1135 adjoining the first side surface 1133 and the second side surface 1134. The first and the second side surfaces 1133, 1134 adjoin the first end surface 1131, and the first bottom surface 1135 is substantially parallel to the first end surface 1131.

The second holder 114 has a structure similar to the first holder 113. The second holder 114 has a second inner side surface 1140, and a second end surface 1141 adjoining the second inner side surface 1140. A distance between the first end surface 1131 and the first surface 1111 is equal to a distance between the second end surface 1141 and the first surface 1111. A second receiving space 1142 is defined in the second holder 114 and exposed at the second end surface 1141. The second receiving space 1142 corresponds to the first receiving space 1132. The first receiving space 1132 and the second receiving space 1142 are configured for supporting the foil reel 20. The second receiving space 1142 has a substantially rectangular cross section. The second receiving space 1142 has a third side surface 1143, a fourth side surface 1144 opposite to the third side surface 1143, and a second bottom surface 1145 adjoining the third side surface 1143 and the fourth side surface 1144. The third and the fourth side surfaces 1143, 1144 adjoin the second end surface 1141. The second bottom surface 1145 is substantially parallel to the second end surface 1141. The first bottom surface 1135 and the second bottom surface 1145 support the spool 21, such that the foil 22 of the foil reel 20 is arranged between the first holder 113 and the second holder 114.

The brake unit 150 applies resistance to the spool 21 of the foil reel 20 received in the first receiving space 1132 and the second receiving space 1142 to balance force exerted by the pulling unit 120 on the foil reel 20. The brake unit 150 includes a first brake 151 and a second brake 152. The first brake 151 is fixed in the first receiving space 1132, and the second brake 152 is fixed in the second receiving space 1142. The first brake unit 151 mechanically connects with one end of the spool 21. The second brake 152 mechanically connects with the other end of the spool 21. In one embodiment, the first brake 151 includes a first resistance component 1511 and a second resistance component 1512. The first resistance component 1511 is fixed on the first side surface 1133; the second resistance component 1512 is fixed on the second side surface 1134. A configuration of first resistance component 1511 and the second resistance component 1512 are longitudinal and substantially semicircular in cross section, with the curved faces thereof facing each other. When voltage is applied, the first resistance component 1511 and the second resistance component 1512approach each other, and a resistant force is applied to the spool 21 therebetween. Increased voltage, increases the resistant force.

The second brake 152 includes a third resistance component 1521 and a fourth resistance component 1522. The third resistance component 1521 is fixed on the third side surface 1143. The fourth resistance component 1522 is fixed on the fourth side surface 1144. Third resistance component 1513 and the fourth resistance component 1514 are longitudinal and substantially semicircular in cross section, with the curved faces thereof facing each other. When voltage is applied, the third resistance component 1513 and the fourth resistance component 1514 approach each other, and a resistant force is applied to the spool 21 therebetween. Increased voltage, increases the resistant force.

The first resistance component 1511, the second resistance component 1512, the third resistance component 1521, and the fourth resistance component 1522 may be magnetic powder brakes or electromagnetic brakes. By controlling the voltage applied to the resistance components, resistance applied on the spool 21 held therebetween is adjusted. It can be understood that the brake unit 150 can include only one brake, mechanically coupled to one end of the spool 21 of the foil reel 20.

The pulling unit 120 is configured for pulling the foil 22 strip from the spool 21. The pulling unit 120 includes a first roller 121, a second roller 122, and two actuating elements 123. The first roller 121 is juxtaposed with the second roller 122 with a gap 124 therebetween. The two actuating elements 123 are mechanically coupled to and rotate the first roller 121 and the second roller 122.

The two actuating elements 123 are respectively fixed on the first end surface 1131 and the second end surface 1141. One end of the first roller 121 is mechanically coupled to one actuating element 123, the other end of the first roller 121 is mechanically coupled to the other actuating element 123, with the first roller 121 positioned therebetween. One end of the second roller 122 is mechanically coupled to one actuating element 123, the other end of the second roller 121 is mechanically coupled to the other actuating element 123, with the second roller 121 positioned therebetween. First roller 121 and second roller 122 extend perpendicular to the first inner surface 1130 and the second inner surface 1140. The first roller 121 is above the second roller 122. Axes of the first roller 121 and the second roller 122 are parallel. The first roller 121 and the second roller 122 are apart from each other. A width of the gap 124 between the first roller 121 and the second roller 122 is less than the thickness of the foil 22 to be cut.

The cutting unit 130 is configured for cutting the foil 22 pulled by the first roller 121 and the second roller 122. The cutting unit 130 is fixed on the first end surface 1131 and the second end surface 1141. The cutting unit 130 includes two drivers 131 and a cutter 132. The two drivers 131 are respectively fixed on the first end surface 1131 and the second end surface 1141. The cutter 132 mounted between the two drivers 131 is parallel to the first roller 121. The cutter 132 is arranged adjacent to the first roller 121. The brake unit 150 and the cutting unit 130 are positioned at two opposite sides of the pulling unit 120. A blade of cutter 132 is adjacent to the second roller 122 and perpendicular to the foil pulling direction. The two drivers 131 drive the cutter 132 close to or away from the foil 22.

The detection unit 160 is configured for recording revolutions of the spool 21 and transmitting an electrical signal corresponding to the obtaining revolutions to the controller 170. The detection unit 160 includes a sensor 161, an attaching roller 162, a fixed shaft 163, a connecting plate 164 and a connecting shaft 165.

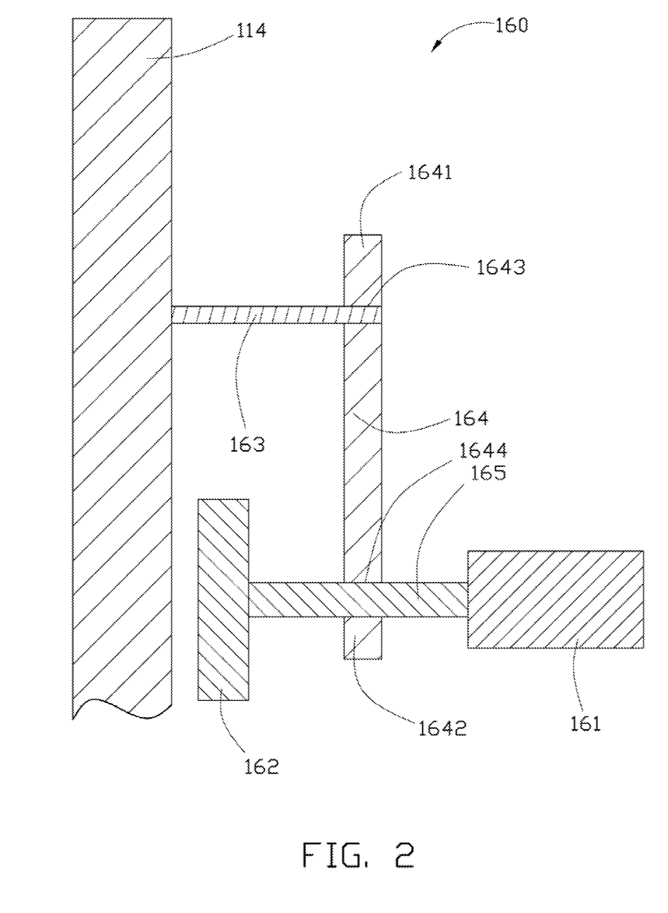

The fixed shaft 163 can be fixed on one of the first holder 113 and the second holder 114. In the illustrated embodiment shown in FIGS. 1 and 2, the fixed shaft 163 is fixed on the second inner surface 1140 of the second holder 114. The fixed shaft 163 is cylindrical and perpendicular to the second inner surface 1140.

The connecting plate 164 is rotatably coupled between the fixed shaft 163 and the connecting shaft 165. The connecting plate 164 is substantially parallel to the second inner surface 1140 and arranged between the first holder 113 and the second holder 114. The connecting plate 164 includes a first end portion 1641 and a second end portion 1642 opposite to the first end portion 1641. A first through hole 1643 is defined in the first end portion 1641. The fixed shaft 163 is received in the first through hole 1643 such that the connecting plate 164 can rotate therearound. A second through hole 1644 is defined in the second end portion 1642.

The connecting shaft 165 is substantially cylindrical and parallel to the fixed shaft 163. A diameter of the connecting shaft 165 is coupled to the second through hole 1644, and the connecting shaft 165 passes through the connecting plate 164 via the second through hole 1644. Accordingly, one end of the connecting shaft 165 is positioned at a side of the connecting plate 164 facing the first holder 113, and the opposite end of the connecting shaft 165 is positioned at a side of the connecting plate 164 facing the second holder 114. The connecting shaft 165 can rotate relative to the connecting plate 164. In one embodiment, a lubricating layer may be arranged between the connecting shaft 165 and an internal wall of the second through hole 1644, to reduce friction therebetween.

The sensor 161 and the attaching roller 162 are respectively fixed to the opposite end of the connecting shaft 165. The attaching roller 162 is adjacent to the second holder 114. The sensor 161 may be an encoder, converting angular displacement to an electric signal. A diameter of the sensor 161 is less than that of the attaching roller 162. The attaching roller 162 is configured for attaching to the outer surface of the spool 21. When the spool 21 rotates, the attaching roller 162 does as well, and the attaching roller 162 and the spool 21 have the same linear speed. When the spool 21 is rotated by the pulling unit 120, the attaching roller 162 rotates at the same linear speed, thus the sensor 161 can sense an angular displacement corresponding to rotation of spool 21.

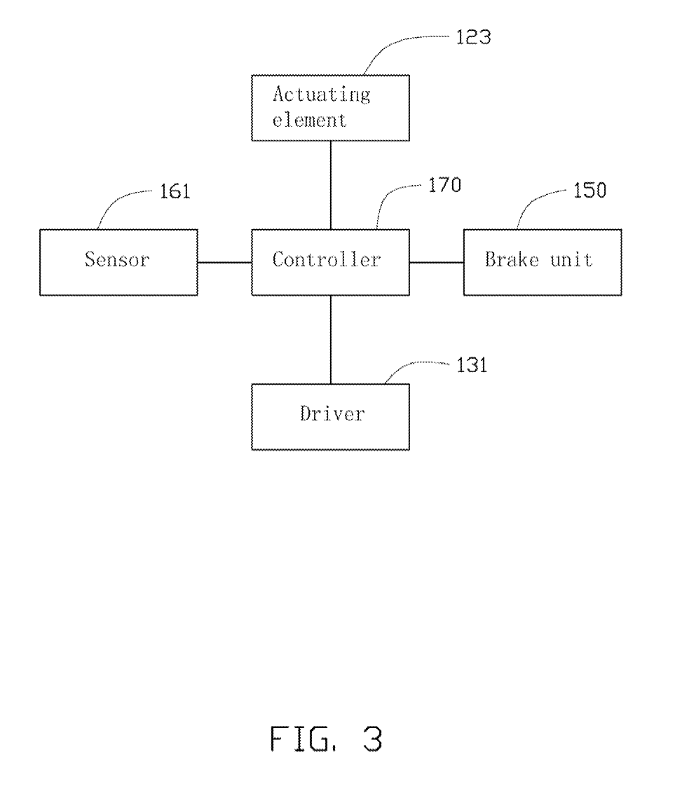

Referring to FIG. 3, the controller 170 is electronically connected to the two actuating elements 123, the two drivers 131, the brake unit 150, and the sensor 161.

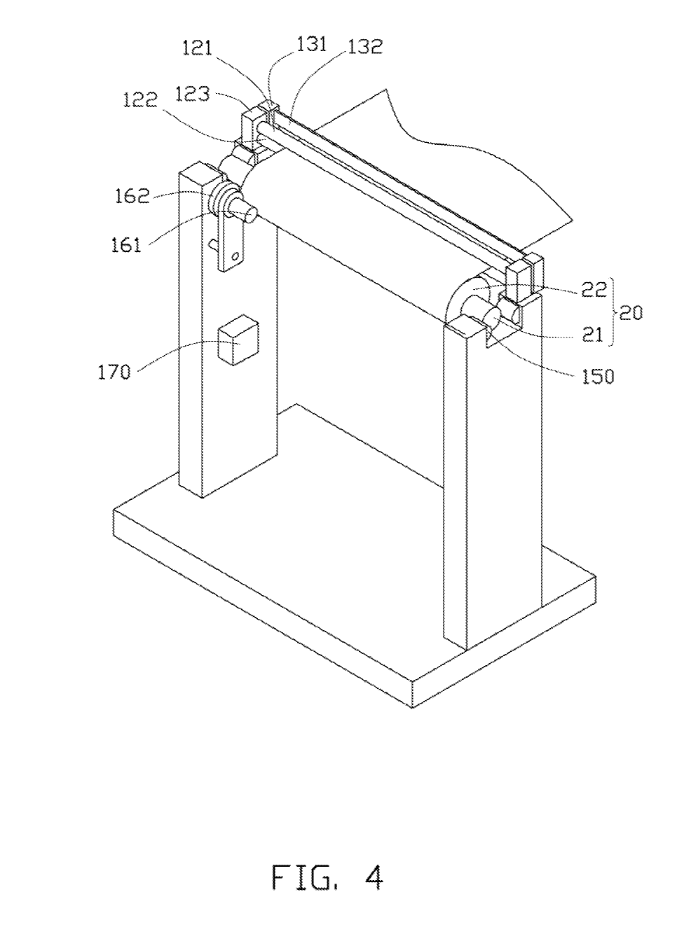

Referring to FIG. 4, the two actuating elements 123 rotate the first roller 121 counterclockwise and the second roller 122 clockwise simultaneously. The foil 22 passes between the first roller 121 and the second roller 122 by friction force therebetween and leaves the spool 21. The controller 170 directs the two actuating elements 123 to rotate first roller 121 and second roller 122 until a desired length of the foil 22 is fed from the spool 21, at which time the controller 170 directs the two drivers 131 to move the cutter 132 to cut the foil 22, and the rollers to cease rotation.

When first roller 121 and the second roller 122 stop rotating, controller 170 directs the brake unit 150 to apply resistance to the spool 21, via the electrical signal transmitted by the sensor 161 corresponding to the revolutions of the reel, preventing further rotation from inertia, with supplied resistance of brake unit 150 variable to correspond to the amount of the foil 22 on the spool 21.

When the spool 21 is wound around foil 22, a diameter thereof corresponds to the mass of the foil 22 on the spool 21, as does inertia generated. The attaching roller 162 attaches to the spool 21 rotates fewer revolutions depending on the mass of the foil 22. The sensor 161 has the same angular speed as the attaching roller 162, and generates a signal corresponding to fewer rotations. The controller 170 adjusts voltage applied to the brake unit 150, which increases resistance to the spool 21.

While various exemplary and preferred embodiments have been described, it is to be understood that the disclosure is not limited thereto. To the contrary, various modifications and similar arrangements (as would be apparent to those skilled in the art), are also covered. Therefore, the scope of the appended claims should be accorded the broadest interpretation so as to encompass all such modifications and similar arrangements.

What is claimed is:

1. An apparatus for cutting a foil strip from a foil reel, the foil feel including a spool and a foil rolled around the spool, the apparatus comprising:
a holding device comprising a first holder and a second holder, the first holder comprising a first end surface and a first receiving space defined in the first end surface, the second holder comprising a second end surface and a second receiving space defined in the second end surface, the first receiving space and the second receiving space configured for receiving the spool;
a cutting unit fixed on the holding device and configured for cutting the foil;
a pulling unit configured for pulling the foil from the foil reel and feeding the foil to the cutting unit;
a brake unit comprising a first brake, the first brake fixed in the first receiving space and mechanically coupled to the spool and configured for applying a resistance to the revolution of the spool;
a detection unit connected to the spool and configured for detecting a rotation speed of the spool; and
a controller electronically connected to the detection unit and the brake unit, and configured for controlling the resistance applied to the spool according to the rotation speed detected by the detection unit.

2. The cutting apparatus as described in claim 1, wherein the first brake comprises a first resistance member and a second resistance member, the first receiving space comprising a first side surface and a second side surface both adjoining the first end surface, the first resistance member is mounted on the first side surface, the second resistant member is mounted on the second side surface.

3. The apparatus as described in claim 1, wherein the controller is configured for controlling a voltage applied to the first brake to control the resistance applied to the spool.

4. The apparatus as described in claim 1, wherein the brake unit further comprises a second brake, the first and the second brakes are mechanically coupled to opposite ends of the spool.

5. The apparatus as described in claim 1, wherein the detection unit comprises a sensor and an attaching roller, the sensor is fixedly connected to the attaching roller and configured for detecting an angular speed of rotation of the attaching roller, and the attaching roller is configured for engaging the spool and rotating at a same linear speed as that of the spool.

6. The apparatus as described in claim 5, wherein the detection unit further comprises a fixed shaft, a connecting plate, and a connecting shaft, the fixed shaft is fixed to the first holder, the connecting plate is rotatably coupled with the fixed shaft, the connecting shaft rotatably passes through the connecting plate, the sensor and the attaching roller are respectively connected to opposite ends of the connecting shaft.

7. The apparatus as described in claim 1, wherein the cutting unit comprises a cutter and a driver, the driver electronically connected to the controller, the controller configured for controlling the driver to drive the cutter to move thus cutting the foil.

8. The apparatus as described in claim 1, wherein the pulling unit comprises a first roller, a second roller and an actuating element, the first roller is parallel to the second roller, the first roller and the second roller mechanically connected to the actuating element, the actuating element configured for driving the first roller and the second roller rotate in opposite directions.

9. An apparatus for cutting a foil strip from a foil reel, the foil reel including a spool and a foil rolled around the spool, the apparatus comprising:
a holding device comprising a first holder and a second holder, the first holder comprising a first end surface, a first receiving space defined in the first end surface, the second holder comprising a second end surface, a second receiving space defined in the second end surface, the first receiving space and the second receiving space configured for receiving opposite ends of the spool;
a cutting unit fixed on the first end surface and the second end surface and configured for cutting the foil;
a pulling unit arranged adjacent to the cutting unit, and configured for pulling the foil out from the foil reel;
a brake unit comprising a first brake, the first brake fixed in the first receiving space and mechanically coupled to the spool and configured for applying a resistance to rotation of the spool;
a detection unit configured for detecting a rotation speed of the spool; and
a controller electronically connected to the sensor, the brake unit, the cutting unit, and the pulling unit, and configured for controlling the pulling unit to pull the foil from the foil reel, controlling the cutting unit to cut the foil, and controlling the resistance applied to the spool according to the rotation speed detected by the sensor.

10. An apparatus for cutting a foil strip from a foil reel, the foil reel including a spool and a foil rolled around the spool, the apparatus comprising:
a holding device comprising two slot portions configured for receivingly supporting opposite ends of the spool;
a cutting unit configured for cutting the foil from the foil reel; a foil pulling unit configured for pulling the foil out from the spool and feeding the foil to the cutting unit;
a brake unit for mechanically engaging the opposite ends of the spool and configured for applying a resistance to rotation of the spool;
a rotation detection unit comprising a sensor and an attaching roller, the sensor fixedly connected to the attaching roller and configured for detecting an angular speed of rotation of the attaching roller, the attaching roller configured for engaging the spool and rotating at a same linear speed as that of the spool; and
a controller electronically connected to the sensor and the brake unit, and configured for controlling the resistance applied to the spool according to the angular speed detected by the sensor.
